(19) United States
(12) Patent Application Publication
(10) Pub. No.: US 2026/0246369 A1
(43) Pub. Date: Aug. 20, 2026

(54) SUBMODULE FOR A MODULAR MULTILEVEL CONVERTER, AND METHOD FOR CARRYING OUT FAST DISCHARGING OF AN ENERGY STORE OF THE SUBMODULE

(71) Applicant: Siemens Energy Global GmbH & Co, KG, Munchen (DE)

(72) Inventors: Ingo Euler, Erlangen (DE); Max Beuermann, Erlangen (DE); Marcus Wahle, Veitsbronn (DE); Daniel Böhme, Nürnberg (DE); Torsten Stoltze, Herzogenaurach (DE); Frank Schremmer, Fürth (DE); Steffen Pierstorf, Nürnberg (DE); Sebastian Kröppel, Hirschaid (DE); Thomas Scholz, Schwandorf (DE); Daniel Schmitt, Postbauer-Heng (DE); Julian Lange, Fürth (DE)

(21) Appl. No.: 19/543,230

(22) Filed: Feb. 18, 2026

(30) Foreign Application Priority Data
Feb. 18, 2025 (DE) 102025105946.2

(51) Int. Cl. H02M 1/32; H02J 7/61; H02J 7/64; H02M 1/088

(52) U.S. Cl. CPC H02M 1/325; H02J 7/61; H02J 7/64; H02M 1/088; H02J 2207/20; H02J 2207/30

(57) ABSTRACT

A submodule for a modular multilevel converter includes a plurality of power semiconductor switching units in a bridge circuit, at least one energy store for storing electrical energy, at least one continuous discharge resistor connected in parallel with the energy store, at least one mechanical bypass switch for bypassing connection terminals of the submodule in a closed state, and at least one control unit to control the power semiconductor switching units and the mechanical bypass switch. A method for carrying out fast and safe discharging of an energy store of a submodule in a modular multilevel converter uses the control unit to drive the power semiconductor switching units during closure or following closure of the mechanical bypass switch in such a way that the energy store is short-circuited via the closed mechanical bypass switch and via at least one of the power semiconductor switching units.

### CROSS-REFERENCE TO RELATED APPLICATION

This application claims the priority, under 35 U.S.C. § 119, of German Patent Application DE 10 2025 105 946.2, filed February 18, 2025; the prior application is herewith incorporated by reference in its entirety.

### FIELD AND BACKGROUND OF THE INVENTION

The invention relates to a submodule for a modular multilevel converter, wherein the submodule has a plurality of power semiconductor switching units disposed in a bridge circuit, at least one energy store for storing electrical energy, at least one continuous discharge resistor connected in parallel with the energy store, at least one mechanical bypass switch configured to bypass connection terminals of the submodule in a closed state, and at least one control unit configured to control the power semiconductor switching units and the mechanical bypass switch.

The invention furthermore also relates to a modular multilevel converter and to a method for carrying out fast discharging of an energy store of a submodule in a modular multilevel converter.

Converters are power electronics circuits for converting electrical energy. Converters may be used to convert AC current into DC current, DC current into AC current, AC current into AC current of another frequency and/or amplitude or DC current into DC current of another voltage. Converters may have a multiplicity of identical submodules that may be electrically connected in series. Those submodules each have at least two power semiconductor switching units and an electrical energy store. Such converters are referred to as modular multilevel converters (MMC or M2C for short).

The electrical series connection of the submodules allows high output voltages to be achieved. The modular multilevel converters are easily adaptable (scalable) to different voltages, and a desired output voltage is able to be produced relatively accurately. Modular multilevel converters are often used in the high-voltage range, for example as converters in high-voltage DC transmission systems (HVDC for short) or as reactive power compensators in flexible three-phase transmission systems (FACTS).

One of the challenges in modular multilevel converters is how to deal with defective submodules.

As a rule, in the event of failure of an individual submodule of the modular multilevel converter, shutdown of the entire system being supplied with power cannot be accepted. For that reason, the faulty submodule has to be put into a safe state during normal operation, and will not be replaced until the next regular shutdown of the system.

In order to enable continued operation even with defective submodules, all submodules are equipped with a mechanical bypass switch able to bypass the respective submodule. That mechanical bypass switch may be installed between submodule terminals (or connection terminals) of the submodule. The system current is thereby able to flow through the faulty submodule without causing damage to the modular multilevel converter, in particular as a result of any arcing that occurs.

Overcharging of the energy store within a cell of the HVDC system may result in damage to components due to the maximum permissible operating voltage being exceeded for a few minutes. The effects of the loading cannot be estimated or controlled. Possible consequences such as plasma formation and arcing during the destruction of those components may, due to the extent thereof, result in the HVDC system being brought to a standstill.

The mechanical bypass switch may be closed, in particular when a defined voltage of the energy store is reached, in order to guide the load current past the suspected faulty component and thus prevent the energy store from being charged further. After the bypass switch has been closed, the stored charge of the energy store is discharged slowly via the (usually high-resistance) continuous discharge resistor. That discharging process may be classed as problematic due to the long duration, defined by the large time constant in the double-digit minute range, since adjacent components in the submodule are exposed to increased voltage loading during a portion of that discharge duration.

In particular in the case of reducing operational losses through the continuous discharge resistor by increasing its resistance value, that results in a comparatively long dwell time of the charge in the energy store and, as a result, the components of the submodule (for example energy stores, power resistors or electronic assemblies) are exposed to the high voltage for a long time.

Safeguards in the configuration of the components must ensure that no faults occur in which the energy store is short-circuited at low resistance. That is because all the stored energy would thereby be released outside the so-called explosion cell of the submodule.

Reducing operational system losses by increasing the resistance value of the discharge resistor would increase component failure due to voltage loading, since in that case they would be exposed to the overvoltage for an even longer time due to the lower discharge current.

### SUMMARY OF THE INVENTION

It is accordingly an object of the invention to provide a submodule for a modular multilevel converter, and a method for carrying out fast discharging of an energy store of the submodule, which overcome the hereinafore-mentioned disadvantages of the heretofore-known devices and methods of this general type and which enable fast but safe discharging of the energy store and protection of the components.

With the foregoing and other objects in view there is provided, in accordance with the invention, a submodule for a modular multilevel converter, wherein the submodule has a plurality of power semiconductor switching units disposed in a bridge circuit, at least one energy store for storing electrical energy, at least one continuous discharge resistor connected in parallel with the energy storage unit, at least one mechanical bypass switch configured to bypass connection terminals of the submodule in a closed state, and at least one control unit configured to control the power semiconductor switching units and the mechanical bypass switch, wherein the control unit is configured to drive the power semiconductor switching units during closure or following closure of the mechanical bypass switch in such a way that the energy store is short-circuited via the closed mechanical bypass switch and via at least one of the power semiconductor switching units.

With the objects of the invention in view, there is also provided a method for carrying out fast discharging of an energy store of a submodule in a modular multilevel converter, wherein the submodule has a plurality of power semiconductor switching units disposed in a bridge circuit, at least one energy store for storing electrical energy, at least one continuous discharge resistor connected in parallel with the energy storage unit, at least one mechanical bypass switch configured to bypass the submodule in a closed state, and at least one control unit configured to control the power semiconductor switching units and the mechanical bypass switch, makes provision for the following method steps: closing the mechanical bypass switch and simultaneously or subsequently driving at least one of the semiconductor switching units in such a way that the energy store is short-circuited via the closed mechanical bypass switch and via the at least one closed power semiconductor switching unit.

With the objects of the invention in view, there is concomitantly provided a modular multilevel converter, comprising at least one submodule according to the invention.

The short-circuiting of the energy store via at least one of the semiconductor switching units enables fast discharging of the energy store. The submodule is thereby able to be brought into a safe state immediately. The action time of the increased voltage loading on components of the submodule, in particular on the energy store and/or electronic assemblies of the submodule, may be reduced to a minimum. One advantage of the invention in this case is that the energy store of the submodule is able to remain in the modular multilevel converter, since it has not been exposed to the overvoltage for too long.

Another advantage of the invention is that the energy stored in the energy store is converted in at least one power semiconductor switching unit. This at least one power semiconductor switching unit, which is used to short-circuit the energy store, may be destroyed by the high current. However, the possible destruction of the power semiconductor switching unit may be accepted deliberately, since the entire submodule no longer has any function relevant to the modular multilevel converter due to the closure of the mechanical bypass switch.

The effects of the destruction of the power semiconductor switching unit may be controlled by a robust environment, in particular by installation in an encapsulated protected cell. In contrast to the other components, the power semiconductor switching unit is installed in the submodule in such a way that the release of energy from the energy store does not impair the function of the adjacent system components.

The continuous discharge resistor of the submodule generally has a high resistance value and is connected to the energy store, in particular by way of a parallel connection, in order to enable slow discharging of the energy store. The short-circuiting of the energy store therefore also means that the discharge resistor is bypassed.

As explained above, the control unit is configured to drive the power semiconductor switching units during or following closure of the mechanical bypass switch in such a way that the energy store is short-circuited via the closed mechanical bypass switch and via at least one of the power semiconductor switching units. In other words, the power semiconductor switching unit may be made to bring about the short-circuiting of the energy store starting from the time when the mechanical bypass switch bypasses the submodule. The faster this takes place, the less time the energy store is exposed to voltage loading.

The solution according to the invention may be improved further by different embodiments that are each advantageous on their own and may be combined with one another as desired. These embodiments and the advantages associated therewith will be discussed below. The improvements described in relation to the submodule may also be applied to the method according to the invention, and so the corresponding advantages come about when the method is carried out. Similarly, the improvements described in relation to the method and the advantages thereof also concern the submodule according to the invention.

According to a first advantageous embodiment of the submodule, the control unit may be configured to monitor a voltage of the energy store and, when a predefined threshold value of the voltage is reached, to close the mechanical bypass switch and the at least one power semiconductor switching unit in order to short-circuit the energy store. The closure of the power semiconductor switching unit refers to closure of at least one power semiconductor in the power semiconductor switching unit. This closure may be achieved by switching on the power semiconductor switching unit. The terms "close" and "switch on" may therefore be used synonymously.

The control unit may, for this purpose, in particular include a monitoring unit for detecting the voltage of the energy store or be connected to the monitoring unit and receive measured values therefrom. The monitoring unit may be configured to send a signal to the control unit when the voltage of the energy store reaches a predefined threshold.

In order to obtain a high-performance energy store, this is preferably formed by a capacitor or includes at least one capacitor.

The power semiconductor switching units preferably each include at least one semiconductor switch and at least one freewheeling diode connected in antiparallel with the semiconductor switch. The semiconductor switches are preferably formed by insulated-gate bipolar transistors, IGBT for short.

Particularly preferably, one of the power semiconductor switching units is connected in parallel with the mechanical bypass switch, wherein the control unit is configured to close this power semiconductor switching unit before the mechanical bypass switch short-circuits the energy store. Faster commutation of the current from the energy store is thereby able to be made possible, and voltage loading of the capacitor is thereby able to be further reduced. The mechanical bypass switch is also protected from high surge currents. This embodiment will be explained in more detail below looking at the method.

According to a further advantageous embodiment of the submodule, the submodule may have exactly two power semiconductor switching units disposed in a half-bridge circuit, wherein, of these two power semiconductor switching units, one power semiconductor switching unit is connected in series with the mechanical bypass switch. This power semiconductor switching unit may be used, together with the mechanical bypass switch, to short-circuit the energy store.

As an alternative to the half-bridge circuit, provision may be made for the submodule to have exactly four power semiconductor switching units disposed in a full-bridge circuit, wherein, of these power semiconductor switching units, one power semiconductor switching unit is connected in series with the mechanical bypass switch. This power semiconductor switching unit may be used, together with the mechanical bypass switch, to short-circuit the energy store.

The advantageous fast and safe discharging of the energy store may be used even in a so-called chopper module, that is to say a power electronics chopper, if the chopper module has at least one power semiconductor switching unit connected in series with the mechanical bypass switch. Like in the case of the submodule according to the invention, this power semiconductor switching unit may be used, together with a mechanical bypass switch of the chopper module, to short-circuit the energy store.

In the abovementioned preferred embodiments of the submodule, a respective power semiconductor switching unit of the submodule, which unit is part of the submodule circuit, is used to create the short circuit. There is therefore no need to provide an additional power semiconductor switching unit to create the short circuit. It is thereby possible to save on components and thus costs. As an alternative, however, it is not ruled out to use additional switchable elements or additional assemblies, which are for example not part of a bridge circuit, to create the short circuit.

However, the uniform use of a power semiconductor switching unit to discharge the energy store offers the possibility of mirroring this discharging concept onto other submodule configurations. Specifically, this means the possibility of fast discharging for half-bridges, full bridges or even chopper modules without additional component expenditure.

The modular multilevel converter according to the invention has at least one submodule according to the invention. The modular multilevel converter preferably has a plurality of submodules according to the invention. They do not all have to be identical. One embodiment of the modular multilevel converter may thus have both submodules in a half-bridge circuit and submodules in a full-bridge circuit. In addition, provision may also be made for at least one chopper module in the modular multilevel converter. Regardless of the configuration of the modular multilevel converter including submodules according to the invention, the modular multilevel converter may include one or more submodules not belonging to the invention in addition to the at least one submodule according to the invention.

The method according to the invention may be further improved by virtue of one of the power semiconductor switching units of the submodule being connected in parallel with the mechanical bypass switch and being closed at a time before the closure of the mechanical bypass switch.

This improvement and the associated advantages will be described briefly below with reference to an example. The power semiconductor switching unit intended to short-circuit the energy store together with the mechanical bypass switch is referred to here as the first power semiconductor switching unit. The power semiconductor switching unit connected in parallel with the mechanical bypass switch is referred to as the second power semiconductor switching unit. The first and second power semiconductor switching unit are generally connected to one another in series.

Switch-on of the second power semiconductor switching unit that is synchronized with the first power semiconductor switching unit causes the charging current for the energy store to initially flow gently from a freewheeling diode of the first power semiconductor switching unit to the semiconductor switch of the second power semiconductor switching unit.

The current, charging the energy store, of the first power semiconductor switching unit thus commutates to the second power semiconductor switching unit without a long delay (a few ten µs), and so the voltage in the energy store does not increase further and the voltage loading of the energy store is thereby lower than if only the mechanical bypass switch alone were to be switched on, since this may have a delay time of several 100 µs before it takes up the charging current.

The energy store may be additionally charged by a few 100 V for this duration. In addition, it is advantageous in the procedure for the mechanical bypass switch to be closed without a high surge current, since, when it is closed, the voltage of the energy store is taken up by the first power semiconductor switching unit.

In the proposed further procedure, after the mechanical bypass switch has safely taken over the current, that is to say after approximately 1 ms, the first power semiconductor switching unit is switched on, and so the energy store quickly discharges in a short circuit from the voltage that is no longer quite so high via the first power semiconductor switching unit and the mechanical bypass switch, wherein the energy is substantially released again only in the so-called explosion cell, since the mechanical bypass switch is already in the closed and thus much more robust state when it is exposed to the surge current.

This procedure avoids overcharging of the energy store beyond the trip voltage of the mechanical bypass switch, surge current loading of the mechanical bypass switch during the sensitive closing operation, and a long duration of high voltage at the submodule components.

For further explanation of the invention, reference is made, in the following part of the description, to figures from which further advantageous details and possible areas of application of the invention may be gleaned. The figures should be understood to be exemplary and are intended to illustrate the character of the invention, but in no way restrict it or even reproduce it definitively. The same reference signs are always used for elements having the same structure and/or the same function.

Other features which are considered as characteristic for the invention are set forth in the appended claims.

Although the invention is illustrated and described herein as embodied in a submodule for a modular multilevel converter, and a method for carrying out fast discharging of an energy store of the submodule, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic circuit diagram of a submodule of a modular multilevel converter;

FIG. 2 is a schematic circuit diagram of the submodule from FIG. 1 during the charging process of the energy store;

FIG. 3 is a schematic circuit diagram of the submodule from FIG. 1 with a closed mechanical bypass switch;

FIG. 4 is a schematic circuit diagram of the submodule from FIG. 1 during the discharging process of the energy store; and

FIG. 5 is a schematic circuit diagram of the submodule from FIG. 1 prior to closure of the mechanical bypass switch in an adapted embodiment of the method.

### DETAILED DESCRIPTION OF THE INVENTION

Referring now to the figures of the drawings in detail and first, particularly, to FIG. 1 thereof, there is seen one advantageous embodiment of a submodule 1 for a modular multilevel converter (not shown). The submodule 1 has connection terminals 3 and 5 via which it is able to be connected to adjacent submodules. This is indicated by the arrows pointing up and down in the drawing.

The submodule 1 has an energy store 7 for storing electrical energy, which is preferably formed by a capacitor 9. The submodule 1 also has a continuous discharge resistor 11.

The submodule 1, illustrated by way of example, has two power semiconductor switching units 13 and 15 disposed in a half-bridge circuit 17. As an alternative to the half-bridge circuit 17, other configurations, not illustrated here, are also possible for the submodule 1. Mention will be made here, solely by way of example, of a full-bridge configuration in which the submodule 1 includes at least two further power semiconductor switching units. A configuration as a chopper module is likewise possible.

The power semiconductor switching unit 13 has a semiconductor switch 19 and a freewheeling diode 21 connected in antiparallel with the semiconductor switch 19.

The power semiconductor switching unit 15 accordingly has a semiconductor switch 23 and a freewheeling diode 25 connected in antiparallel with the semiconductor switch 23.cc

The semiconductor switches 19 and 23 are preferably formed by IGBTs. The semiconductor switch 19 may be referred to as Top-IGBT 27, and the semiconductor switch 23 may be referred to as Bot-IGBT 29.

The submodule 1 has a mechanical bypass switch 31 connected in parallel with the power semiconductor switching unit 15 and thus in parallel with the semiconductor switch 23.

The mechanical bypass switch 31 is able to bypass the submodule 1 by bringing about a short circuit between the two connection terminals 3 and 5 in its on state.

In order to control and preferably also monitor the components of the submodule 1, provision is made for a control unit 33 configured to send switch-on signals to the semiconductor switches 19 and 23 and to the mechanical bypass switch 31. The control unit 33 is indicated in dashed form in FIG. 1. It may be data-connected, in particular electrically or optically, to the elements to be switched.

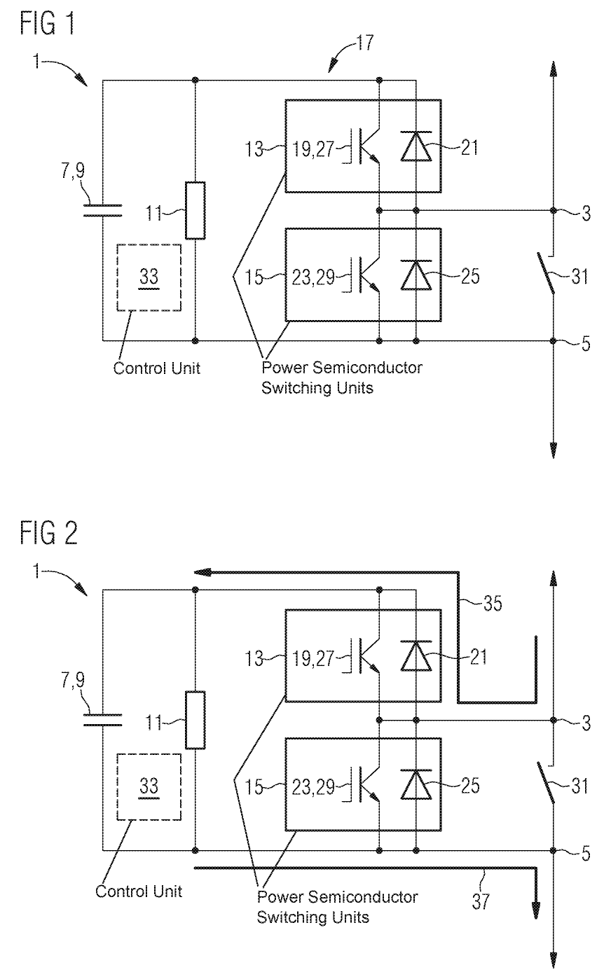

FIG. 2 uses arrows 35 and 37 to illustrate a portion of the current flow able to charge the capacitor 9 during operation.

If a fault occurs in the submodule 1, the submodule is able to be bypassed in order to maintain the operation of the modular multilevel converter. In order to bypass the submodule 1, the mechanical bypass switch 31 is closed. This may be initiated in particular by the control unit 33, which may be data-connected to the mechanical bypass switch 31.

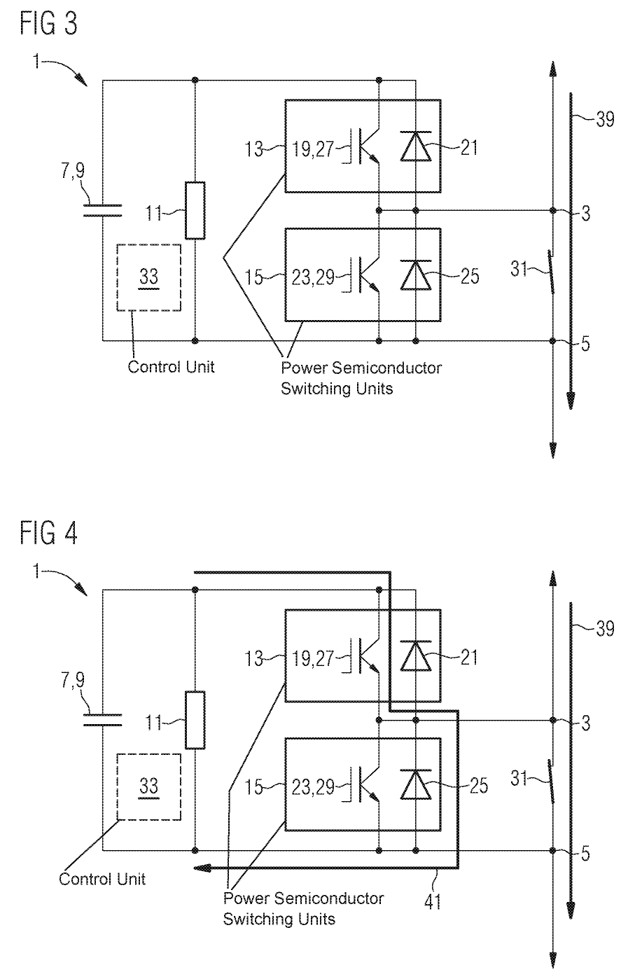

A submodule 1 with a closed mechanical bypass switch 31 is illustrated in FIG. 3. The current then flows between the two connection terminals 3 and 5 via the closed mechanical bypass switch 31. This is indicated by the arrow 39 in FIG. 3.

The capacitor 9 is then no longer charged. However, the electrical energy stored in the capacitor 9 only flows away slowly via the discharge resistor 11. The high voltage, which thereby acts for a long time, may damage the components of the submodule 1, in particular the capacitor 9 itself.

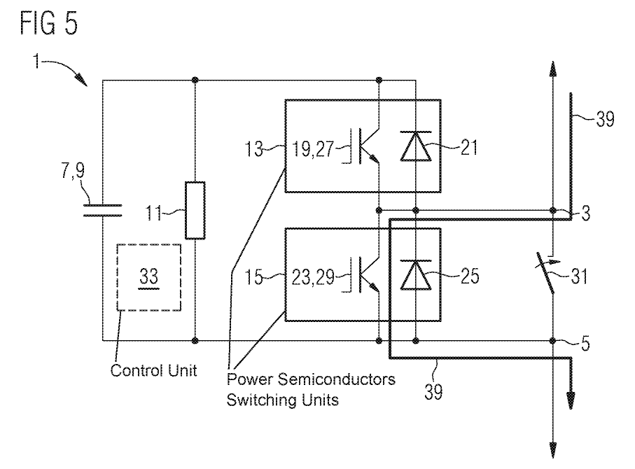

In order to discharge the capacitor 9 safely but faster than is possible via the discharge resistor 11, provision is made for the power semiconductor switching units to be driven in such a way that the capacitor 9 is short-circuited. In order to achieve this short-circuiting, preferably, the power semiconductor switching unit 13 is driven and the Top-IGBT 27 is switched on. This situation is illustrated in FIG. 4.

The electrical energy stored in the capacitor 9 may then, with the mechanical bypass switch 31 closed, be discharged via the Top-IGBT 27 and the mechanical bypass switch 31. This is indicated by the arrow 41 in FIG. 4.

One optional improvement to the submodule 1 and the method for carrying out fast discharging of the energy store 7 is illustrated in FIG. 5 and described briefly below.

The power semiconductor switching unit 15, connected in parallel with the mechanical bypass switch, may take over the current at a time before the closure of the mechanical bypass switch 31, and thus also before switch-on of the power semiconductor switching unit 13.

Switch-on of the power semiconductor switching unit 15 that is synchronized with the power semiconductor switching unit 13 causes the charging current for the energy store 7 to initially flow gently from a freewheeling diode 21 of the power semiconductor switching unit 13 to the semiconductor switch 23 of the power semiconductor switching unit 15.

The current, charging the energy store 7, of the power semiconductor switching unit 13 thus commutates to the power semiconductor switching unit 15 without a long delay (a few ten µs), and so the voltage in the energy store 7 does not increase further and the voltage loading of the energy store 7 is thereby lower than if only the mechanical bypass switch 31 alone were to be switched on, since this may have a delay time of several 100 µs before it takes up the charging current.

The energy store 7 may be additionally charged by a few 100 V for this duration. In addition, it is advantageous in the procedure for the mechanical bypass switch 31 to be closed without a high surge current, since, when it is closed, the voltage of the energy store 7 is taken up by the power semiconductor switching unit 13.

In the proposed further procedure, after the mechanical bypass switch 31 has safely taken over the current, that is to say after approximately 1 ms, the power semiconductor switching unit 13 is switched on, and so the energy store 7 quickly discharges in a short circuit from the voltage that is no longer quite so high via the power semiconductor switching unit 13 and the mechanical bypass switch 31, wherein the energy is substantially released again only in a so-called explosion cell (not illustrated), since the mechanical bypass switch 31 is already in the closed and thus much more robust state when it is exposed to the surge current.

This procedure avoids overcharging of the energy store 7 beyond the trip voltage of the mechanical bypass switch 31, surge current loading of the mechanical bypass switch 31 during the sensitive closing operation, and a long duration of high voltage at the components of the submodule 1.

The following is a summary list of reference numerals and the corresponding structure used in the above description of the invention:

1 Submodule

3, 5 Connection terminals

7 Energy store

9 Capacitor

11 Continuous discharge resistor

13, 15 Power semiconductor switching unit

17 Half-bridge circuit

19 Semiconductor switch

21 Freewheeling diode

23 Semiconductor switch

25 Freewheeling diode

27 Top-IGBT

29 Bot-IGBT

31 Mechanical bypass switch

33 Control unit

35, 37, 39, 41 Current flow direction

1. A submodule for a modular multilevel converter, the submodule comprising:
connection terminals of the submodule;
a plurality of power semiconductor switching units disposed in a bridge circuit;
at least one energy store for storing electrical energy;
at least one continuous discharge resistor connected in parallel with said at least one energy store;
at least one mechanical bypass switch configured to bypass said connection terminals of the submodule in a closed state; and
at least one control unit configured to control said plurality of power semiconductor switching units and said at least one mechanical bypass switch;
said at least one control unit configured to drive said plurality of power semiconductor switching units during closure or following closure of said at least one mechanical bypass switch, causing said at least one energy store to be short-circuited via said at least one closed mechanical bypass switch and via at least one of said plurality of power semiconductor switching units.

2. The submodule according to claim 1, wherein said at least one control unit is configured to monitor a voltage of said at least one energy store and, when a predefined threshold value of the voltage is reached, to close said at least one mechanical bypass switch and said at least one power semiconductor switching unit in order to short-circuit said at least one energy store.

3. The submodule according to claim 1, wherein said at least one energy store is a capacitor or includes at least one capacitor.

4. The submodule according to claim 1, wherein one of said plurality of power semiconductor switching units is connected in parallel with said at least one mechanical bypass switch, and said at least one control unit is configured to close said one power semiconductor switching unit before said at least one mechanical bypass switch short-circuits said at least one energy store.

5. The submodule according to claim 1, wherein said plurality of power semiconductor switching units each include a semiconductor switch and a freewheeling diode connected in antiparallel with said semiconductor switch.

6. The submodule according to claim 5, wherein said semiconductor switches are formed by IGBTs.

7. The submodule according to claim 1, wherein said plurality of power semiconductor switching units includes exactly two power semiconductor switching units disposed in a half-bridge circuit, and one of said exactly two power semiconductor switching units is connected in series with said at least one mechanical bypass switch.

8. The submodule according to claim 1, wherein said plurality of power semiconductor switching units includes exactly four power semiconductor switching units disposed in a full-bridge circuit, and one of said exactly four power semiconductor switching units is connected in series with said at least one mechanical bypass switch.

9. A modular multilevel converter, comprising at least one submodule according to claim 1.

10. A method for carrying out fast discharging of an energy store of a submodule in a modular multilevel converter, the method comprising:
providing the submodule, the submodule having a plurality of power semiconductor switching units disposed in a bridge circuit, at least one energy store for storing electrical energy, at least one continuous discharge resistor connected in parallel with the at least one energy store, at least one mechanical bypass switch configured to bypass the submodule in a closed state, and at least one control unit configured to control the plurality of power semiconductor switching units and the at least one mechanical bypass switch; and
closing the at least one mechanical bypass switch and simultaneously or subsequently driving at least one of the plurality of semiconductor switching units, causing the at least one energy store to be short-circuited via the at least one closed mechanical bypass switch and via the at least one closed power semiconductor switching unit.

11. The method according to claim 10, which further comprises connecting one of the plurality of power semiconductor switching units in parallel with the at least one mechanical bypass switch, and closing the one power semiconductor switching unit at a time before closure of the at least one mechanical bypass switch.
